(19) United States
(12) Patent Application Publication
(10) Pub. No.: US 2008/0167764 A1
(43) Pub. Date: Jul. 10, 2008

(54) ICE RATE METER WITH VIRTUAL ASPIRATION

(76) Inventor: Robert James Flemming, Trumbull, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/971,367

(22) Filed: Jan. 9, 2008

Related U.S. Application Data
(60) Provisional application No. 60/879,967, filed on Jan. 10, 2007.

(51) Int. Cl. B64D 15/20; G06F 7/00; G06F 19/00

(52) U.S. Cl. 701/14; 244/134 F

(57) ABSTRACT

A system and method of determining an actual liquid water content (Actual LWC) with an ice rate meter probe without aspiration.

The present application claims priority to U.S. Provisional Patent Application Ser. No. 60/879,967, filed 10 Jan. 2007.

### BACKGROUND

The present invention relates to an ice rate meter with a virtual aspiration effect which eliminates bleed air aspiration.

Aircraft may encounter atmospheric conditions that may cause the formation of ice. Accumulated ice, if not removed, may add weight to the aircraft and may alter the aircraft flying characteristics.

Aircraft ice rate meters detect icing conditions and quantify the intensity of the icing condition. Current ice rate meters may have reduced accuracy over some portion of the aircraft flight envelope. Vertical takeoff and landing (VTOL) aircraft operate over a wide range of airspeeds and are particularly susceptible to reduced ice rate meter accuracy over the expansive VTOL aircraft flight envelope.

To increase accuracy over these portions of the aircraft flight envelope, the ice rate meter is provided with an added velocity. This added velocity is typically achieved through aspiration where engine bleed air is ducted to the ice rate meter probe to induce additional airflow into the ice rate meter probe. An aspirated ice rate meter includes an air duct extending from the engine to the probe and as a result there may be some measure of engine power loss from usage of the engine bleed air.

The high bleed air temperature and pressure of gas turbine engines may complicate conventional ice rate meter design. Some ice rate meter designs also require bleed air filtering and bleed air metering to purify and control the engine bleed air utilized for aspiration which may increase system weight and complexity. Furthermore, engine bleed air temperature and pressure varies with engine power settings which may affect the accuracy of an aspirated probe.

### SUMMARY

A system according to an exemplary aspect of the present invention includes an ice rate meter probe with virtual aspiration.

A method of determining an actual liquid water content (Actual LWC) with an ice rate meter probe without aspiration according to an exemplary aspect of the present invention includes acquiring measured liquid water content (Measured LWC) data from an ice rate meter probe; acquiring measured data from an aircraft sensor suite; correlating a virtual aspiration factor with the measured data from the aircraft sensor suite; and determining an actual liquid water content (Actual LWC) by applying the virtual aspiration factor to the measured liquid water content data.

### BRIEF DESCRIPTION OF THE DRAWINGS

The various features and advantages of this invention will become apparent to those skilled in the art from the following detailed description of the disclosed non-limiting embodiment. The drawings that accompany the detailed description can be briefly described as follows:

FIG. 1 is a general perspective view of one exemplary rotary wing aircraft embodiment for use with the present invention;

FIG. 2 is a block diagram of an ice protection system according to one embodiment of the present invention;

FIG. 3 is a graphical representation of a measured LWC (Measured LWC) divided by an actual LWC (Actual LWC) illustrating a compensating virtual aspiration between a nominal zero error LWC measurement and a LWC measurement without aspiration;

FIG. 4 is a graphical representation of an example curve for a ratio of the probe error as a function of bleed air. This curve is based on the subtraction of truth (in this case a liquid water content value of 0.5 grams/cubic meter) from the probe value;

FIG. 5 is a plot of the values of error ratio at zero bleed air pressure. Data used is the same as in FIG. 4;

FIG. 6 is a plot of the “velocity virtual aspiration factor” that utilizes the data in FIG. 4 and corrects an actual probe output and produces values that replicate “truth” (e.g., actual liquid water content values) This curve is essentially the inverse of the FIG. 5 curve. An ice rate meter with virtual aspiration includes a programmed equation that accounts for the errors of an aspirated probe, but with a magnitude that accounts for the effects of aspiration which results in an ice rate meter probe that meets accuracy requirements without the air of bleed air flow. The programmed equation or equations are suitable to provide required accuracy when the aspiration bleed air flow is eliminated;

FIG. 7 is a plot of a “pressure altitude virtual aspiration factor” that may be utilized in combination with the “velocity virtual aspiration factor”;

FIG. 8 is a plot of a “static temperature altitude virtual aspiration factor” that may be utilized in combination with the “velocity virtual aspiration factor”; and

FIG. 9 is a schematic flowchart representation of the ice rate measurement performed by the ice protection system.

### DETAILED DESCRIPTION OF THE EXEMPLARY EMBODIMENTS

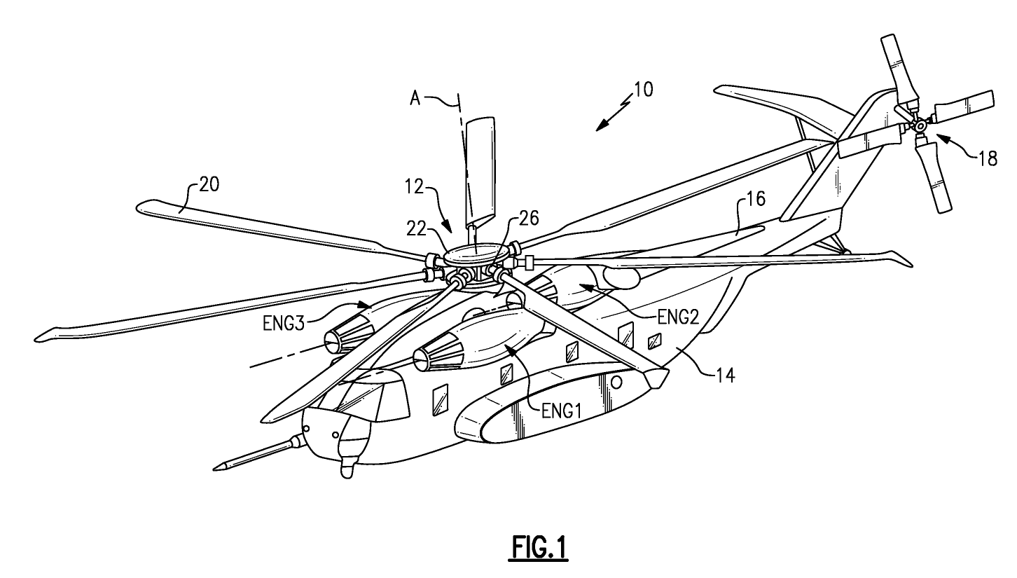

FIG. 1 schematically illustrates an exemplary vertical takeoff and landing (VTOL) rotary-wing aircraft 10. The aircraft 10 in the disclosed, non-limiting embodiment includes a main rotor system 12 supported by an airframe 14 having an extending tail 16 which mounts an antitorque system 18 such as a tail rotor system. The main rotor assembly 12 is driven about an axis of rotation R through a main gearbox MRG by one or more engines ENG (in this example, three engines ENG1-ENG3 are shown). The main rotor system 12 includes a multiple of rotor blades 20 mounted to a rotor hub 22. Although a particular VTOL rotary-wing aircraft configuration is illustrated and described in the exemplary embodiment, other configurations and/or machines, such as high speed compound rotary wing aircraft with supplemental translational thrust systems, dual contra-rotating, coaxial rotor system aircraft, fixed wing aircraft, VTOL aircraft, turbo-props, tilt-rotors and tilt-wing aircraft, will also benefit herefrom.

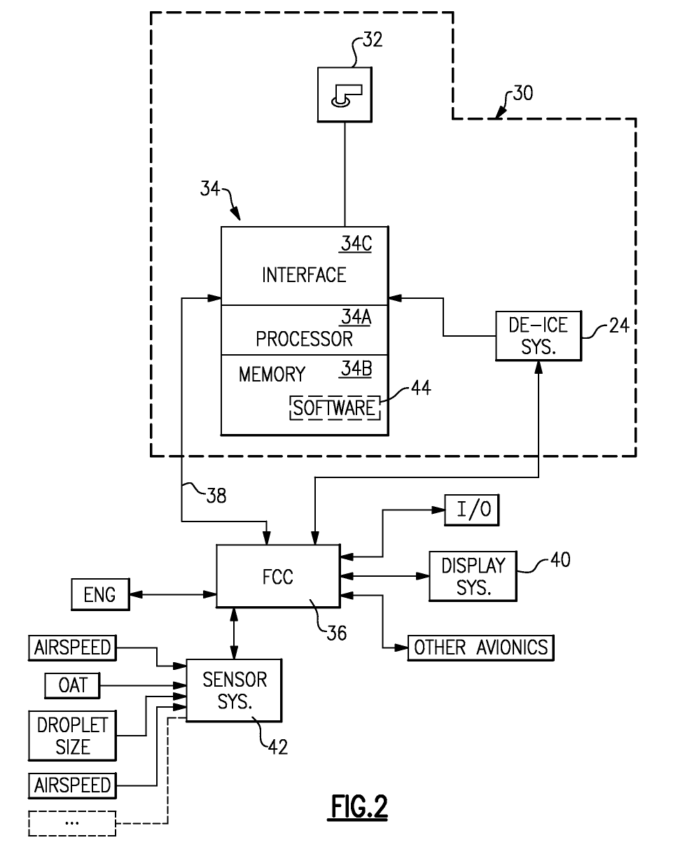

Referring to FIG. 2, an ice protection system 30 is schematically illustrated in a block diagram format. The ice protection system 30 generally includes an ice rate meter probe 32 in communication with an ice rate module 34.

The ice rate module 34 typically includes a processor 34A, a memory 34B, and an interface 34C for communicating with other avionics, systems and components such as a central flight control computer (FCC) 36. The ice rate module 34, in one non limiting embodiment, is in communication with the FCC 36 over a digital data bus 38. The ice rate module 34 may operate to control a deice system 24 directly or through the FCC 36. The deice system 24 may include, for example only, a leading edge heater mat within each rotor blade 20 (FIG. 1).

The FCC 36 is in communication with other avionics systems and components such as the aircraft engines ENG, a cockpit instrument display system 40 and an aircraft sensor suite 42. Although the FCC 36 is schematically illustrated as a single block, it should be understood that the FCC 36 herein may include multiple computers having multiple channels and multiple redundant subsystems.

The cockpit instrument display system 40 typically includes one or more analog and/or digital displays in electrical communication with the FCC 36. The cockpit instrument display system 40 operates to control avionics and to display data therefrom as symbology to interface with an aircrew. Although the cockpit instrument display system 40 is illustrated as a single block, it should be understood that the cockpit instrument display system 40 may include multiple subsystems such as data concentrator units (DCUs), multifunction displays (MFDs), primary flight displays (PFDs) and other systems such as line replaceable units (LRUs).

The aircraft sensor suite 42 communicates data to the FCC 36. With aircraft digital busses, sensor data available to the FCC 36 such as, for example only, airspeed, outside air temperature (OAT), pressure altitude, water drop size, and such like aircraft data is also thereby available to the ice rate module 34. The ice rate module 34 may store data, software and control algorithms such as a virtual aspiration software 44 to correct the measured ice accretion on the ice rate meter probe 32 in the memory device 34C for operation of the processor 34A. The data, software and control algorithms may alternatively be stored in the memory 34B as RAM, ROM or other computer readable medium either in the ice rate module 34 and/or the FCC 36. The stored data, software and control algorithms are one example of a scheme by which decisions are made and operations are performed based thereon.

The virtual aspiration software 44 can enhance the accuracy of ice rate measurement and eliminate the heretofore need for bleed air aspiration of the ice rate meter probe active element. The ice rate module 34 utilizes a virtual aspiration factor to provide virtual aspiration for the ice rate meter probe 32. It should be understood that airspeed, outside air temperature (OAT), pressure altitude, water drop size, and such like sensor data and data parameters derived therefrom, which are available to the FCC 36 may alternatively, additionally or in various combinations be utilized to provide the virtual aspiration. The usage of these data parameters provide an ice rate meter probe 32 that is accurate to relatively low airspeeds at which the angle of flow to the probe becomes so large that the Liquid Water Content (LWC) value would be inaccurate even with actual bleed air aspiration.

The virtual aspiration software 44 with data from the aircraft sensor suite 42 provides the virtual aspiration to correct the measured ice accretion on the ice rate meter probe 32. The virtual aspiration software 44 provides virtual aspiration through, for example only, a virtual aspiration factor. The virtual aspiration factor minimizes the ice rate meter probe 32 error over a wide variation of icing flight conditions. The virtual aspiration factor, in one non-limiting embodiment, is defined through aircraft flight test data, a computational fluid dynamics (CFD) code, and/or by tests in a wind tunnel, which should obtain, e.g., the highest fidelity.

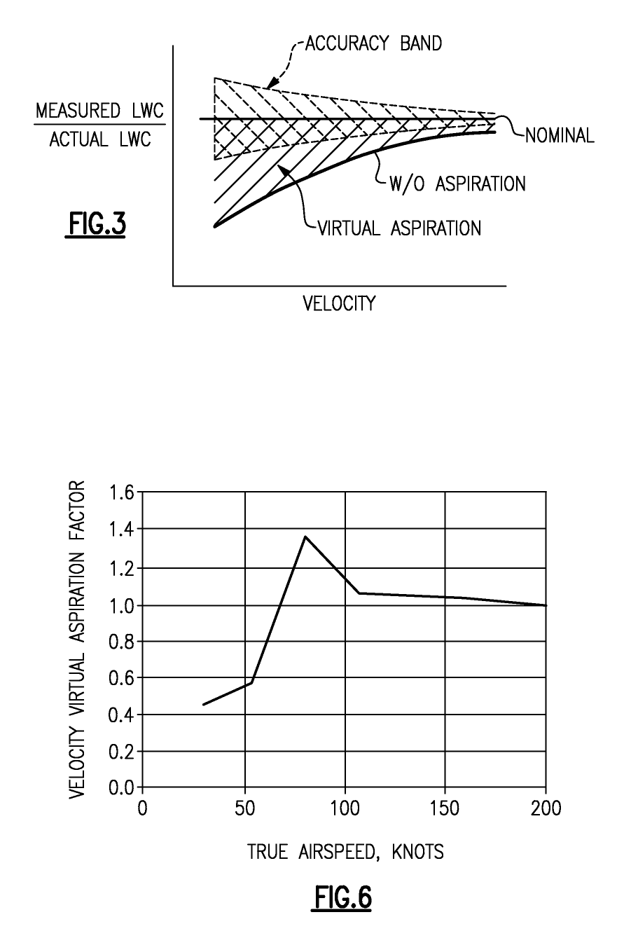

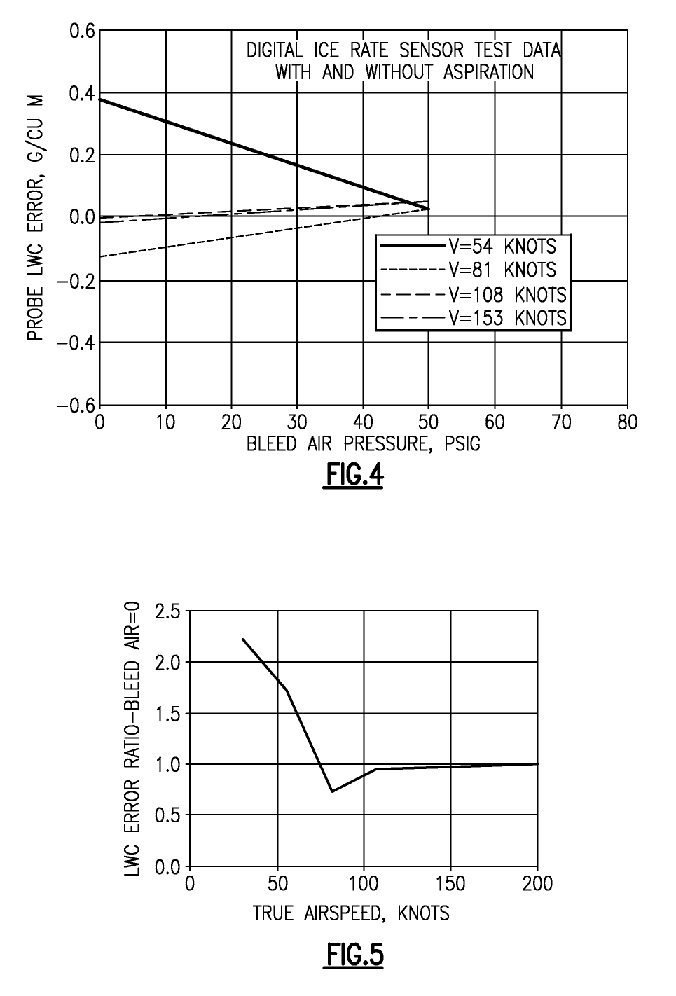

Referring to FIG. 3, a nominal zero error Liquid Water Content (LWC) measurement may be defined as a straight line. That is, a measured LWC (Measured LWC) divided by an actual LWC (Actual LWC) results in the nominal zero error LWC measurement when the measured and actual LWC are perfectly accurate. The ice rate meter probe 32 should operate within a particular accuracy band which generally increases as airspeed decreases. Even with the decreasing accuracy that occurs at lower airspeeds, the ice rate meter probe 32 will still provide an error outside of the accuracy band without aspiration. An example curve for a ratio of the probe error as a function of bleed air is illustrated in FIG. 4. An example plot of the values of error ratio at zero bleed air pressure is illustrated in FIG. 5.

The virtual aspiration software 44 includes at least one virtual aspiration factor (see, e.g., FIG. 6) to reduce ice rate meter probe 32 error. The virtual aspiration software 44 accounts for the errors of an aspirated probe, but with a magnitude that accounts for the effects of aspiration. The result is an ice rate meter probe 32 (and associated ice protection system 30) that meets accuracy requirements without bleed air flow. Even an airspeed-related correction factor alone provided by the virtual aspiration software 44 can be applied to drive the data from the ice rate meter probe 32 to essentially zero error. That is, the virtual aspiration software 44 provides an Actual LWC determined by a Measured LWC from the ice rate meter probe 32 multiplied by the velocity virtual aspiration factor. A velocity virtual aspiration factor (see, e.g., FIG. 6) utilizes the error ratio at zero bleed air pressure (see FIG. 5) and corrects the actual ice rate meter probe output to generate values that replicate true LWC (e.g., actual LWC). The FIG. 6 curve is in an example essentially the inverse of the FIG. 5 curve.

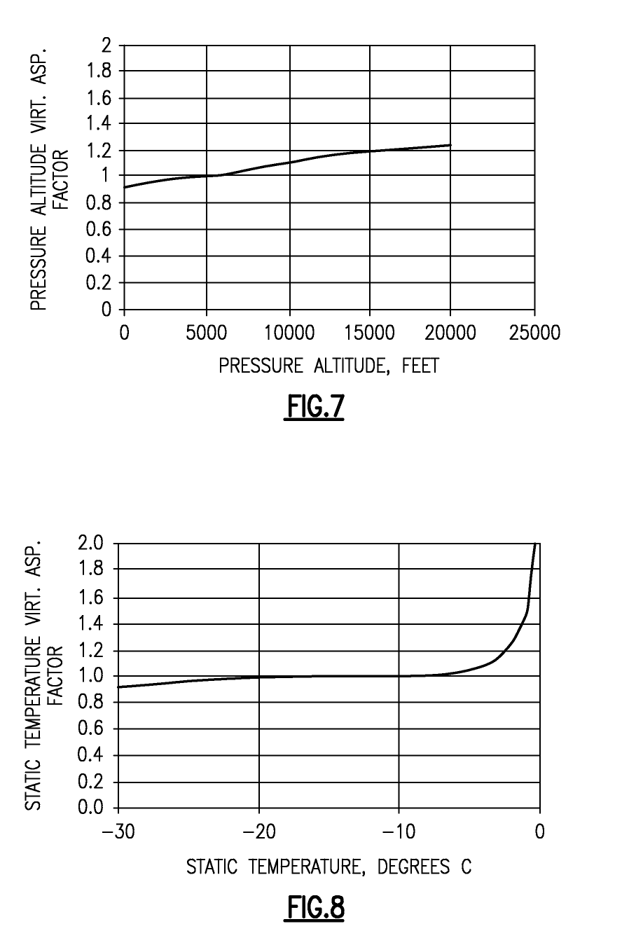

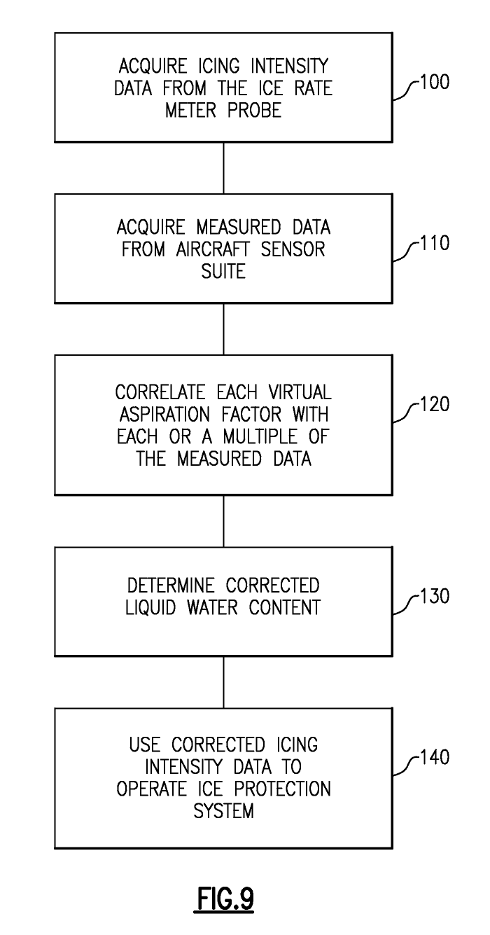

Similar virtual aspiration factor plots may be utilized for any other parameter, such as a pressure altitude virtual aspiration factor (FIG. 7), a static temperature virtual aspiration factor (FIG. 8), drop diameter or such like.

In operation and with reference to FIG. 9, the calculation of liquid water content (LWC) by the virtual aspiration software 44 may proceed generally as follows.

In step 100, icing intensity liquid water content data sample (e.g., Measured LWC) is acquired in icing conditions from the ice rate meter probe 32.

In step 110, measured data is acquired from the aircraft sensor suite 42, (e.g., Measured LWC from the ice rate meter probe 32; true airspeed; outside air temperature (OAT); pressure altitude; drop diameter; etc.) typically available to the FCC 36.

In step 120, the virtual aspiration factor is correlated with one or a multiple of the measured data (e.g., true airspeed; outside air temperature (OAT); pressure altitude; drop diameter; etc).

In step 130, the Actual LWC is determined by multiplying the virtual aspiration factor (which could be a matrix of factors) by the appropriate measured data from the aircraft sensor suite (including the Measured LWC from the ice rate meter probe 32). In one non limiting embodiment, the Actual LWC=Velocity Virtual Aspiration Factor (a function of true airspeed) multiplied by (“×”) measured LWC. It should be understood that the Velocity Virtual Aspiration Factor could be a function of variables other than velocity.

In another non limiting embodiment, the Actual LWC=(Velocity Virtual Aspiration Factor (a function of true airspeed)×measured LWC) added to (“+”+(Temperature Virtual Aspiration Factor (a function of static or total temperature)×measured LWC)+(Pressure Altitude Virtual Aspiration Factor (a function of pressure altitude)×measured LWC)+(Drop Diameter Virtual Aspiration Factor (a function of supercooled water drop diameter)×measured LWC). These factors may alternatively or additionally be weighted. That is, various combination of various Virtual Aspiration Factors may alternatively or additionally be utilized.

In step 140, the Actual LWC is then utilized to perform the desired aircraft operations such as, for example only, operation of the deice system 24, display by cockpit instrument display system 40 and such like.

Ice rate meter probe 32 in combination with ice rate module 34 with virtual aspiration, as part of the ice protection system 30, provides an accurate ice accretion measurement over the full range of the aircraft flight envelope for operation in icing conditions which eliminates bleed aspirations, reduces ice rate meter costs and complexity, reduces system weight, improves reliability, and improves engine performance. By way of example only, Applicant has provided an ice protection system 30 that obtains an approximate 10 percent improvement in reliability and approximately 10 pounds in weight savings at a cost savings compared to current ice rate meter systems.

It should be understood that even an ice rate meter probe originally designed with aspiration capability could be utilized with the present invention by removal of aspiration tubing system and placing a plug in the aspiration input port.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. Although certain particular exemplary embodiments of this invention have been disclosed, one of ordinary skill in the art would recognize that certain modifications would be within the scope of this invention. It is, therefore, to be understood that within the scope of the appended claims, the invention may be practiced otherwise than as specifically described. For that reason the following claims should be studied to determine the true scope and content of this invention.

What is claimed:

1. A system for an aircraft comprising:
an ice rate meter probe operable to acquire a measured liquid water content (Measured LWC); and
an ice rate module in communication with said ice rate meter probe, said ice rate module operable to determine a virtual aspiration factor, and to determine a representation of an actual liquid water content using at least said virtual aspiration factor and the Measured LWC, wherein said representation is suitable for use to adjust at least a portion of a deice system.

2. The system as recited in claim 1, wherein said virtual aspiration factor includes a factor which is a function of aircraft airspeed.

3. The system as recited in claim 1, wherein said virtual aspiration factor includes a factor which is a function of outside air temperature.

4. The system as recited in claim 1, wherein said virtual aspiration factor includes a factor which is a function of pressure altitude.

5. The system as recited in claim 1, wherein said virtual aspiration factor includes a factor which is a function of water drop size.

6. The system as recited in claim 1, wherein said virtual aspiration factor includes a factor which is a function of at least one of: an aircraft airspeed, an outside air temperature, a pressure altitude, or a water drop size.

7. The system as recited in claim 1, wherein said ice rate module is operable to determine said virtual aspiration factor relative to aircraft data.

8. The system as recited in claim 1, further comprising a flight control computer, and wherein said ice rate module is in communication with said flight control computer.

9. The system as recited in claim 8, further comprising a sensor suite in communication with said flight control computer, said sensor suite operable to determine aircraft data.

10. The system as recited in claim 9, wherein said aircraft data includes data representative of an aircraft airspeed and suitable for use by the ice rate module for determination of said virtual aspiration factor.

11. The system as recited in claim 9, wherein said aircraft data includes data representative of a pressure altitude and suitable for use by the ice rate module for determination of said virtual aspiration factor.

12. The system as recited in claim 9, wherein said aircraft data includes data representative of a temperature and suitable for use by the ice rate module for determination of said virtual aspiration factor.

13. The system as recited in claim 9, wherein said aircraft data includes data representative of a supercooled water drop diameter and suitable for use by the ice rate module for determination of said virtual aspiration factor.

14. The system as recited in claim 9, further comprising said deice system in communication with said flight control computer to deice at least one aircraft component, wherein said flight control computer adjusts said deice system based at least in part on information corresponding to said representation.

15. The system as recited in claim 9, further comprising a cockpit display system in communication with said flight control computer.

16. The system as recited in claim 1, further comprising a deice system in communication with said ice rate module to deice at least one aircraft component.

17. The system as recited in claim 16, further comprising a sensor suite in communication with said ice rate module, said sensor suite operable to determine aircraft data wherein said ice rate module adjusts said deice system based at least in part on said aircraft data.

18. The system as recited in claim 1, further comprising a flight control computer, and wherein said ice rate module is in communication with said flight control computer.

19. The system as recited in claim 18, further comprising a sensor suite in communication with said flight control computer, said sensor suite operable to determine aircraft data.

20. The system as recited in claim 19, further comprising a deice system in communication with a flight control computer to deice at least one aircraft component wherein said flight control computer adjusts said deice system based at least in part on said aircraft data.

21. A method comprising:
acquiring measured liquid water content (Measured LWC) data from an ice rate meter probe;
acquiring measured data from an aircraft sensor suite;
correlating a virtual aspiration factor with the measured data from the aircraft sensor suite; and
determining an actual liquid water content (Actual LWC) by applying the virtual aspiration factor to the measured liquid water content data.

22. A method as recited in claim 21, wherein determining the actual liquid water content includes the function: Actual LWC=a value corresponding to a function of aircraft airspeed×Measured LWC.

23. A method as recited in claim 21, wherein determining the actual liquid water content includes the function: Actual LWC=(a value corresponding to a function of aircraft airspeed×measured LWC)+(a value corresponding to a function of static or total temperature×measured LWC)+(a value corresponding to a function of pressure altitude×measured LWC)+(a value corresponding to a function of supercooled water drop diameter×measured LWC).

24. A method as recited in claim 21, further comprising:
using said actual liquid water content to adjust a deice system.

25. A method as recited in claim 21, further comprising:
communicating a representation of the actual liquid water content to a deice system; and
adjusting the deice system at least in part on said representation

26. A method comprising:
acquiring measured data from an aircraft sensor suite;
multiplying a virtual aspiration factor which is a function of the measured data by a measured liquid water content (Measured LWC) to obtain an actual liquid water content (Actual LWC); and
using said Actual LWC to adjust a deice system of an aircraft.

27. A method as recited in claim 26, wherein the virtual aspiration factor includes a is a function of true airspeed.
